(19) United States
(12) Patent Application Publication
(10) Pub. No.: US 2012/0130727 A1
(43) Pub. Date: May 24, 2012

(54) COMMUTER REWARD SYSTEMS AND METHODS

(75) Inventor: Shahir Anwar Ahmed, League City, TX (US)

(73) Assignee: CommutePays LLC, League City, TX (US)

(21) Appl. No.: 13/088,067

(22) Filed: Apr. 15, 2011

Related U.S. Application Data
(60) Provisional application No. 61/416,741, filed on Nov. 24, 2010.

(51) Int. Cl. G06Q 30/00

(52) U.S. Cl. 705/1.1

(57) ABSTRACT

Methods and systems are disclosed for rewarding a commuter. A value of a characteristic of a commute by the commuter along a route from a first location to a second location is determined. The value of the characteristic is compared with a reference value for the characteristic for travel by the commuter along the route from the first location to the second location to determine that the determined value deviates from the reference value by more than a threshold amount. A reward to the commuter is generated in response to determining that the determined value deviates from the reference value by more than the threshold amount.

### CROSS-REFERENCE TO RELATED APPLICATION

This application is a nonprovisional of U.S. Prov. Pat. Appl. No. 61/416,741, entitled “BUSINESS METHOD PATENT FOR TRACKING, MEASURING, ANALYZING AND MONETIZING COMMUTER TRAVEL TIME, DISTANCE, PATTERNS, AND PAIN THRESHOLDS FOR USE AS AN EXCHANGEABLE AND TANGIBLE VALUE FOR SUBSCRIBERS AND ADVERTISERS OF MOBILE PHONE APPLICATIONS,” filed Nov. 24, 2010 by Shahir Ahmed, the entire disclosure of which is hereby incorporated by reference for all purposes.

### BACKGROUND OF THE INVENTION

This application relates generally to reward systems and methods. More specifically, this application relates to systems and methods in which rewards are provided to commuters based on their commute quality.

Commuting is a relatively recent phenomenon that is characteristic of the industrialization of modern society. Before the 19th century, most workers lived only a short walk from the places where they were employed. But with the rise of industrialization, including particularly improvements in methods of transportation, many workers are now employed at locations distant from their homes. The particular demographic reasons for this change are manyfold, including particularly the concentration of employment in city centers where residential costs may be high, thereby causing individuals to live in lower-cost areas outside city centers.

There have been many effects arising from this shift, notably in the demographic structure of population distributions, particularly near larger cities. Large cities are now typically surrounded by commuter belts in which large populations of commuting employees live. But infrastructures are limited in the volume of different kinds of traffic that can be accommodated. When coupled with the fact that a significant majority of jobs have daily start and end times that fall within relatively narrow windows of time, a number of difficulties result. Roads used by cars and buses, rail lines used by trains, and other alternative commuting infrastructures tend to become congested at peak commuting times. This causes frustration and stress among commuters, often at sufficient levels to affect health in patterns that have been documented.

Most commuters develop a certain tolerance to their commutes, incorporating general expectations for travel time and conditions into their daily routines, but the level of frustration and stress can be amplified by unexpected events: unusually heavy traffic, road accidents, railcar breakdowns, inclement weather, and the like. The impact of these unexpected events can be substantial: employees may be reprimanded for tardiness, they may be late for important meetings or to pick up children from daycare, and suffer other consequences.

A number of systems exist to aid commuters in addressing these potential issues. Radio stations routinely include traffic reports during times of high commuter-traffic volume both to prepare listeners for known commuting issues and to permit them to devise alternative commuting strategies. This technique has recently been adopted also with a number of different internet interfaces that can be consulted by individuals both to identify potential issues with their normal commuting routes and to be advised of alternative routes.

But even with these systems, commuting remains something that occupies a large portion of the day for many people and which is dominated by negative aspects.

### SUMMARY

Embodiments of the invention provide a method of rewarding a commuter. A value of a characteristic of a commute by the commuter along a route from a first location to a second location is determined. The value of the characteristic is compared with a reference value for the characteristic for travel by the commuter along the route from the first location to the second location to determine that the determined value deviates from the reference value by more than a threshold amount. A reward to the commuter is generated in response to determining that the determined value deviates from the reference value by more than the threshold amount.

In some embodiments, the value of the characteristic comprises a time for travel by the commuter along the route from the first location to the second location. The reference value of the characteristic may comprise an average time for travel by the commuter along the route from the first location to the second location.

In some embodiments, the value of the reference characteristic may be updated to account for the determined value of the characteristic. The threshold amount may comprise a statistical measure of variation from the reference value for the characteristic for travel by the commuter along the route from the first location to the second location. In some instances, the commute may comprise a plurality of commutes along the route from the first location to the second location, with the plurality of commutes having a further common quality. The reward to the commuter may be generated by augmenting a point record associated with the commuter and redeemable for goods and/or services.

In some embodiments determining the value of the characteristic comprises monitoring a location of a mobile device associated with the commuter as the commuter travels along the route from the first location to the second location. In such embodiments, the characteristic may be determined by predicting the value of the characteristic for an entirety of the commute from partial information of the commute collected while monitoring the location of the mobile device. In such instances, the reward may be generated before the commute is complete, and the value of the characteristic may be predicted by accessing and applying external information collected from a source other than the mobile device.

The methods of the invention may be embodied in a system that comprises a processor, a communications system, and a storage device. The communications system is in communication with the processor and with a network accessible by a mobile device associated with the commuter. The storage device is in communication with the processor, which has instructions to implement the methods summarized above.

### BRIEF DESCRIPTION OF THE DRAWINGS

A further understanding of the nature and advantages of the present invention may be realized by reference to the remaining portions of the specification and the drawings, wherein like reference labels are used through the several drawings to refer to similar components. In some instances, reference labels are followed with a hyphenated sublabel; reference to only the primary portion of the label is intended to refer collectively to all reference labels that have the same primary label but different sublabels.

FIG. 1 provides a schematic illustration of a system for providing commuting rewards;

FIG. 2 is a block diagram illustrating a server structure on which embodiments of the invention may be embodied;

FIG. 3A provides an illustration of a mobile device with which embodiments of the invention may be implemented;

FIG. 3B is a block diagram illustrating an internal structure of the mobile device of FIG. 3A; and

FIGS. 4A, 4B, and 4C are flow diagrams illustrating aspects of methods of the invention.

### DETAILED DESCRIPTION OF EXEMPLARY EMBODIMENTS

Embodiments of the invention are directed to systems and methods that provide rewards to commuters. Notably, the rewards are generally provided for passive behavior by the commuter, being prompted by deviations from commutes that are considered abnormal for the commuter. This is unlike conventional reward systems, which most commonly take the form of loyalty reward systems in which consumers are rewarded for loyal behavior towards a product or service. For instance, airlines commonly provide reward incentives to induce customers to fly on particular carriers, providing points that may be redeemed for free flights, class upgrades, free or upgraded accommodations, and the like. In many ways, such airline loyalty programs illustrate the basic paradigm for the way in which other loyalty reward systems operate in a wide diversity of industries, including programs operated by large retail providers, credit service providers, auto-repair service providers, and many others. By rewarding commuters for passive behavior, embodiments of the invention take a nonconventional approach to providing rewards.

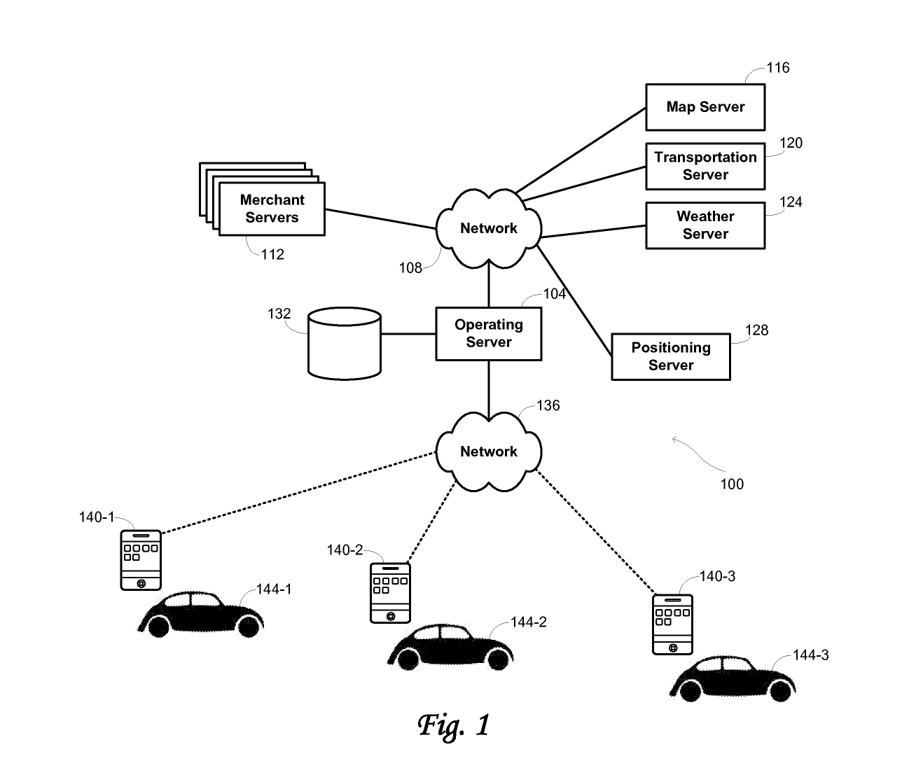

A basic illustration of a system that may be used to implement the reward scheme is provided with FIG. 1. The system 100 is organized about an operating server 104, which has access to information from a variety of sources, as well as software configured to implement methods of the invention. Some of the information is available local to the operating server 104, such as from a data store 132 provided in direct communication with the operating server 104. Other information is available from remote sources that may be accessed by the operating server 104 over one or more networks 108. The networks 108 may be private networks in some embodiments, or may be public networks, in which case at least some of the interactions between the operating server 104 and the other data sources may be effected with appropriately secure encryption techniques.

The drawing provides several examples of remote data sources that may be used in a particular embodiment, although there are other sources that may be accessed in other embodiments and it is possible that some of those explicitly identified might be omitted in some embodiments. A set of merchant servers 112 allows the operating server to coordinate the use of accumulated reward points with the merchants who operate those servers 112. As discussed in greater detail below, such use may take a number of different forms, including the direct honoring of accumulated points by the merchants or the issuance of either electronic or hard-copy coupons for use at the merchants.

The other data sources shown in the drawing provide the operating server 104 with access to information that it uses in monitoring and evaluating commutes. A map server 116 provides access to detailed and current roadmaps, including such information as speed limits on individual roads, restrictions on traffic direction, restrictions on vehicle type, and the like. A transportation server 120 provides access to current transportation information such as may be maintained by a governmental transportation authority. The transportation information may include real-time information that specifies traffic levels on individual roads, current average vehicle speeds on individual roads, the presence of construction sites, the presence of accidents with a summary assessment of the severity of such accidents, and the like. A weather server 124 provides access to current weather information, providing the operating server 104 with information on current and forecast precipitation patterns, temperatures, and the like.

The operating server 104 may also be capable of communicating with other types of servers, notably servers that actively participate in real-time evaluation of commutes by interacting with mobile devices 140 carried by commuters. One example of such a server is shown in the drawing in the form of a positioning server 128 that provides the operating server 104 with real-time information on a position of each commuter device 140 being monitored. Such position information may be derived from global-positioning systems (“GPS”) or from multilateration-based localization techniques that correlate signal strength received by mobile-device antenna masts relatively proximate to the device 140 being monitored. Other techniques may alternatively be used, including hybrid positioning techniques that use a combination of network-based and handset-based location-determination technologies such as assisted GPS.

In addition to being in communication with the various servers through networks 108, the operating server 104 is in communication with the mobile devices 140 through a further network 136. This network 136 may comprise a cellular wireless network such as those that satisfy the 3G and 4G standards or may comprise a wi-fi network, provided sufficient coverage is provided with the network 136 to ensure substantially continuous communication with the mobile devices 140. The mobile devices 140 are generally carried by commuters during their commutes, as illustrated schematically in the drawing by associating them with commuter vehicles 144. The mobile devices may take any of a variety of different forms, provided that they have the ability to have their locations monitored and to communicate with the operating server 104 by having a connection with network 136. Examples of mobile devices that may be used with embodiments of the invention include cellular telephones, tablet computers, laptop computers, handheld game devices, personal digital assistants, enterprise digital assistants, portable media players, digital cameras, and the like.

Communication with the mobile devices 140 advantageously allows the collection of information that may be used predictively. In particular, in some embodiments, machine-learning techniques are used to generate symbiotic algorithms derived from subscriber-base information. At a general level, such algorithms may be considered as resulting from a derivation of pattern behavior from dynamic positioning based on data collected from individual commuters. These algorithms may be implemented by the operating server 104 with data that are stored on the data store 132.

Merely by way of example, consider a city that provides enough subscribers to the system that the collected information allows the application of predictive modeling techniques to the commuting system as a whole. The operating server 104 may identify data, one example of which is deviations in single-commuter positioning data. With enough commuters subscribing to the system, the collected data permits derivation of predictive algorithms so that the system may understand when heavier-than-normal traffic will occur.

In one illustration, deviations may be determined by examining relevant data quantities over successive small time increments to derive time gradients that allow determination of variances. By monitoring and analyzing these data and creating relationships with other commuters along the same paths to identify similar data-point deviations, group pattern convergences may be identified to predict traffic patterns. In different embodiments, machine-learning techniques such as neural network, stochastic techniques, or the like may be used to refine and improve the derived algorithms as data continue to be collected.

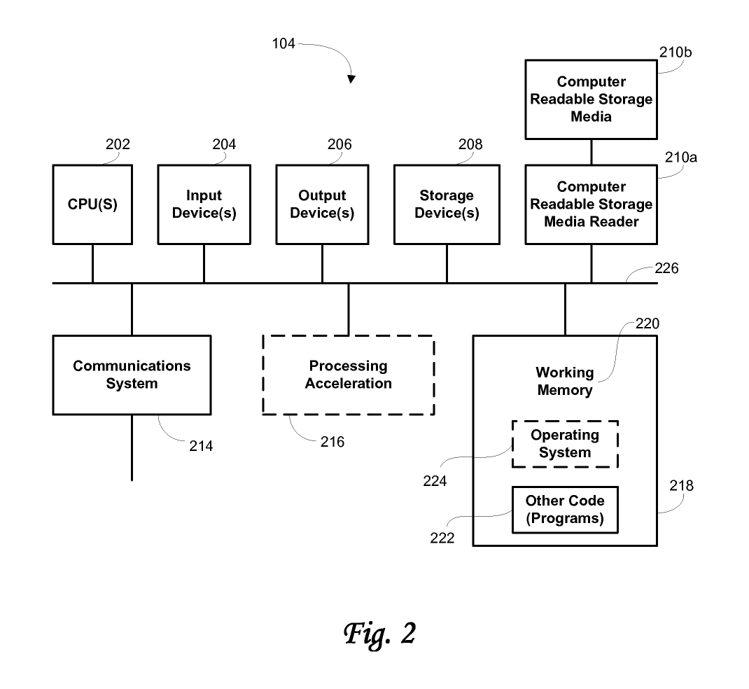

FIG. 2 is a block diagram illustrating a structure for the operating server 104 on which embodiments of the invention may be implemented. The operating server 104 is shown comprised of hardware elements that are electrically coupled via bus 226, including a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with external devices as desired.

The operating server 104 also comprises software elements, shown as being currently located within working memory 220, including by way of example but not limited to an operating system 224 and other code 222, such as a program designed to implement methods of the invention. It should be understood that operating system 224 can be considered optional and in some implementations code such as machine code implementing embodiments of the present invention can be executed directly by CPU 202 without reliance on an operating system. It will be apparent to those skilled in the art that substantial other variations may be made in accordance with specific requirements. For example, customized hardware might also be used and/or particular elements might be implemented in hardware, software (including portable software, such as applets), or both. Further, connection to other computing devices such as network input/output devices may be employed.

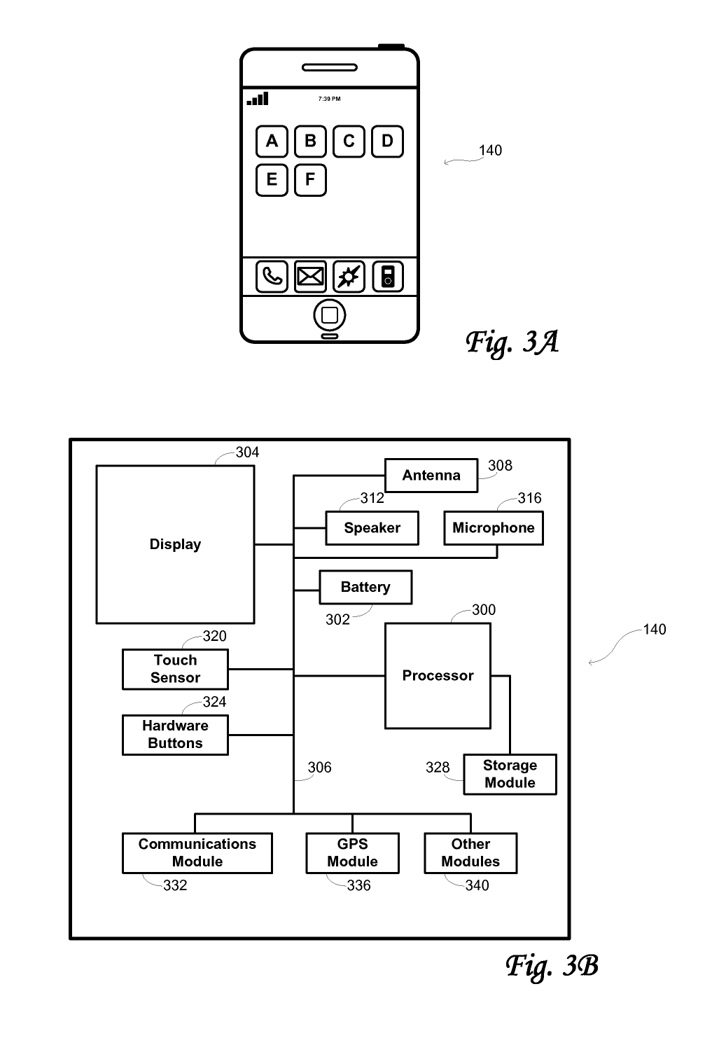

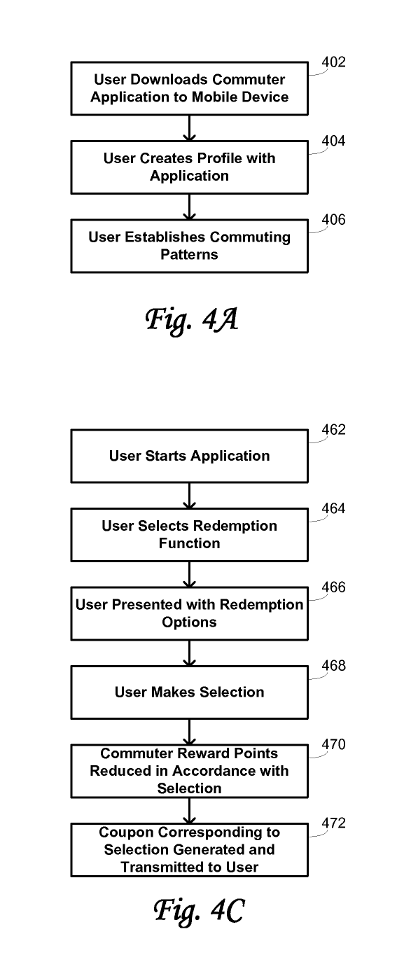

FIGS. 3A and 3B provide illustrations an example of a mobile device 140 that may be used by commuters, with FIG. 3A showing an external structure and FIG. 3B showing an internal structure. While the mobile device 140 is shown in this example, it may be embodied as any mobile device, including the different structures mentioned above.

Internal to the mobile device 140 are a number of different modules, as illustrated with the block diagram of FIG. 3B. While the illustration identifies a number of functional components, it is to be understood that alternative devices may lack some of these specific components and may sometimes include other components not specifically described. Power is provided with a battery 302 that is coupled through a bus 306 so that each of those components may draw power from the battery 302 during operation. The components that enable interaction between the device 140 and a user include one or more displays 304, one or more touch sensors 320, hardware buttons 324, one or more speakers 312, and one or more microphones 316. The displays 304 allow for visual forms of interaction with the user, with input from the user being collected through the touch sensors 320 and/or hardware buttons 324, while the speakers 312 and microphones 316 allow for audio forms of interaction.

A position of the device 140 may be determined and tracked with a GPS module 336, which is one example of modules internal to the device 140 that interact with a communications module 332 by accessing GPS satellite signals. The communications module 332 may additionally be operable to communicate with any of a variety of networks 136, enabling communication with cellular networks, wifi networks, and the like, as described in connection with FIG. 1. Such communications may be coordinated through operation of an antenna 308 to access and generate electromagnetic signals used in communication with the device 140. Other types of communications, notably through electrical cables, may be effected by operation of other modules 340 such as an input/output module configured for coupling of the device 140 with other devices or peripherals. Other examples of other modules 340 that might be included as part of the mobile device 140 include camera modules in devices equipped to collect images, accelerometer modules in devices equipped to identify an orientation of the device 140, and the like.

All of these modules may have their operation coordinated by a processor 300 that interacts with a storage module 328. The processor 300 may be embodied as one or more application-specific integrated circuits (“ASICs”), one or more field-programmable gate arrays (“FGPAs”), or one or more general-purpose processors operative to execute machine-readable instructions in the form of code.

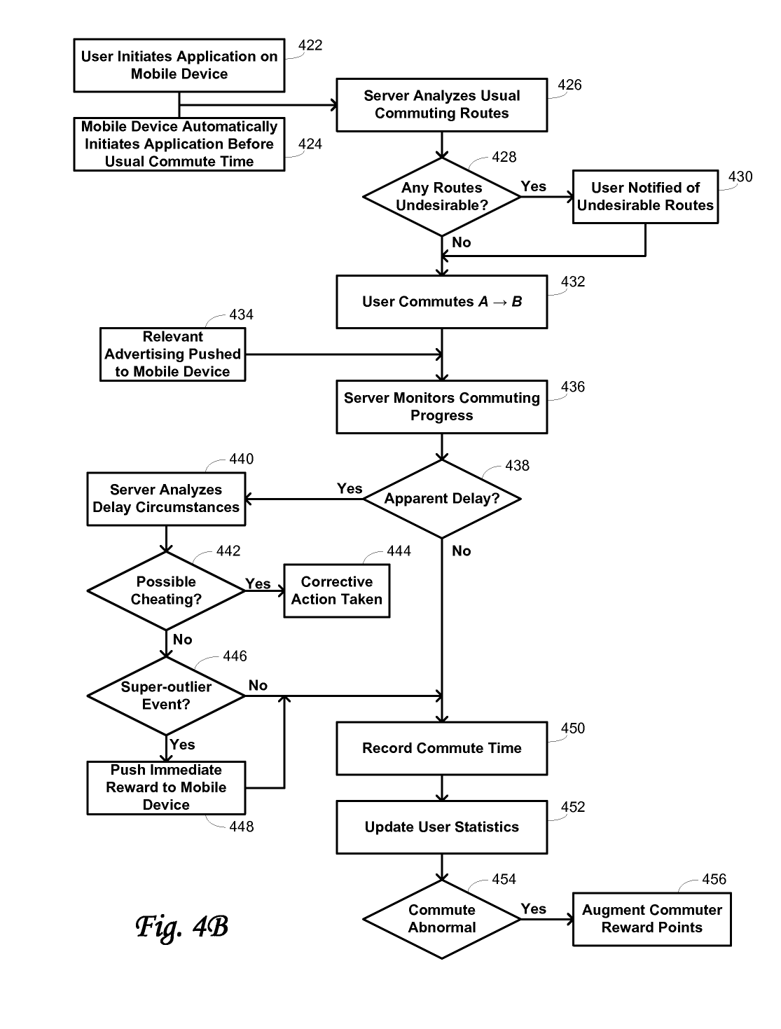

Methods of the invention are summarized with the flow diagrams of FIGS. 4A-4C. It is noted that while the flow diagrams identify specific method steps in a particular order that this is not intended to be limiting. In alternative embodiments, the identified steps may be performed in a different order, some steps may be omitted, and/or some additional steps not specifically shown may additionally be performed.

FIG. 4A summarizes aspects of the methods related to initially configuring a commuter application for monitoring the commuting behavior of a user. The user downloads the commuter application to the mobile device 140 at block 402. This may be done in a variety of different ways to known to those of skill in the art. For example, the application may be downloaded directly from a provider of the application or may be downloaded from a more centralized applications store that makes a variety of different applications available. The commuter application may be provided according to different financial conditions in different embodiments. For example, the commuter application and its total functionality might be provided free of charge. Alternatively, the commuter application itself might be provided free of charge while a subscription fee might be imposed for access to its functionality, perhaps after an introductory free trial period. In some embodiments, different subscription levels are available to different users, with the resulting rewards being made at correspondingly different levels. Still other financial arrangements for download and/or use of the commuter application will be evident to those of skill in the art.

At block 404, the user creates a profile with the commuter application. Profile information may be cursory or detailed in different embodiments. Generally, profile information includes at least specification of a mechanism to contact the user, but may also include information that may be used in tailoring rewards suitable for the interests of the user. The profile information may be stored locally on the device 140 in the storage module 328 and/or may be stored locally to the operating server 104 in data store 132.

Once the user has been appropriate registered with the operating server 104 by creating a profile that is stored, the user establishes commuting patterns for use by the commuting application at block 406. The commuting application usually has at least one commuting pattern for a particular user, which includes a route from a home location to a functional location and back, with the functional location being a site where the user works, attends school, engages in volunteer activities, and the like. In some embodiments, the commuting application may store a plurality of commuting patterns that represent alternative routes that the user sometimes takes in commuting between the home and functional locations. Storage of a plurality of commuting patterns enables the application to recommend which of the particular patterns may be preferred according to existing traffic, weather, accident, and similar conditions.

Establishment of the commuting patterns at block 406 may be achieved in a number of different ways in different embodiments. In one embodiment, the user defines a commuting patterning by using an interface provided with the commuting application on the mobile device 140 itself. This may take the form of having the mobile device 140 present a map on the display 304 after entry of address information for home and functional locations so that the map may be traced by the user to define the commuting pattern. The device 140 might also be used directly by having the device generate a tree display of travel options that may be selected by the user in defining the commuting pattern. Alternative to specification of commuting patterns through interaction the mobile device 140, users may instead use a feature in which the operating server 104 monitors locations of the device 140 as the user performs an actual commute, recording the path taken by the user. This may be done by initiating a feature of the commuter application to record a commuting pattern at the home location and terminating it at the functional location (or with the initiation and termination reversed for a return commute).

Establishment of the commuting patterns at block 406 generally includes not only establishing the route for the commute, but also establishing other relevant factors such as a time of day when the commute is typically performed, the variation in the start time for the commute, the average time length of the commute itself, and the variation on the time length of the commute. Different embodiments may use different statistical measures in defining the average and variation for these parameters. Merely by way of example, the mean and standard deviation may conveniently be used, but other alternative measure may be used in other embodiments, including such measures as the median, the range, the mean deviation, the variance, and the like. In still other alternative embodiments, the entire statistical distribution of values may be maintained.

With commuting patterns established, the application is prepared to monitor commutes by the user and to provide rewards. Methods of doing so are summarized with the flow diagram of FIG. 4B.

The methods may begin with initiation of the application on the mobile device 140 at either block 422 or block 424. In some instances, the user may initiate the application as indicated at block 422, but in other embodiments indicated at block 424, the mobile device 140 may automatically initiate the application before the usual commute time, relying on the established commuting patterns to determine an initiation time. Typical automatic initiation times may, for example, correspond to a fixed time before the mean time for departing on a commute on commuting days.

Regardless whether the user initiates the application at block 422 or the mobile device 140 initiates the application automatically at block 424, the operating server 104 may analyze the usual commuting routes established as part of the commuting patterns at block 426. Such an analysis may compare traffic conditions as informed by the transportation server 120 along each of the usual commuting routes, may consider weather conditions as informed by the weather server 124 to account for known systematic variations in commuting times as a result of weather conditions, and the like. In some embodiments, the analysis performed at block 426 may consider alternative commuting routes that are not part of the set of usual commuting routes as established by the commuting patterns.

If any of the routes are undesirable, as checked at block 428, the user may be informed of such undesirable routes at block 430 and perhaps also advised of alternative routes that are preferable based on existing commuting conditions. Such alternative routes may be selected from the set of usual routes as defined by the commuting patterns or may be alternative routes that were considered even though the user does not consider them to be usual routes. If all usual routes are flagged by the system as undesirable, a reward may be issued in some embodiments.

Based on this information of advisable commuting routes, the user commutes with the mobile device 140 from location A to location B at block 432, where each of locations A and B are one of the home and functional locations. The commute may be passive in the sense that the user proceeds along a chosen path from A to B without external direction information, or may be active with the mobile device 140 providing direction information to define progress along the commuting path.

During the commute or at other times, relevant advertising may be pushed from the operating server 104 to the mobile device 140 as indicated at block 434. The advertisements may originate from the merchant servers 112, but decisions of which advertisements to push at particular times is preferably controlled by the operating server 104. When pushed in this way, the advertising is preferably tailored to be of interest to the particular user based on information in the user's profile and/or location information as the commute is monitored. For example, if a user is known to drink coffee, an advertisement for a coffee shop known to be near the user's current location may be pushed to the user's mobile device at block 434. One approach to pushing advertising is to engage significant sponsors in providing a holding credit used for outlier events such as those described below in connection with block 446. In some instances, links may also be provided to social media sites in response to identifying business opportunities with individuals or subgroups of the commuting population.

Throughout the commute, the server may monitor progress of the commute at block 436. Such monitoring may be relatively simple or more complex in different embodiments. For instance, location information of the mobile device 140 may be substantially continuously recorded and compared with an expected position of the mobile device 140 according to the established commuting patterns. Through the application of statistical techniques, a decision may be made at block 438 whether the commute appears to be suffering from a delay.

The statistical techniques may vary among different embodiments, but may be illustrated with a simple example. Consider a commute that the commuting patterns have established has a mean commuting time of 30 minutes with a 5 minute standard deviation along a route that has a substantially constant speed limit. If 20 minutes have passed and the commuter has traversed only 35% of the total distance of the commute, the application identifies that the commute appears to be delayed because the deviation from the expected commuting distance based on the commuting patterns is greater than a single standard deviation.

More sophisticated statistical evaluations of a commute take into account the fact that certain portions of the commute are expected to proceed more slowly than other portions of the commute because of variations in speed limits, the presence of traffic lights, expected incidences of higher traffic volume, and the like. In addition, a single standard deviation as a threshold trigger may be inappropriate for portions of certain commuting routes, particularly if there are systematic relationships known to the system in which delays in one portion of a commute are typically correlated with improvements in another portion of the commute. Some embodiments may accordingly use different statistical thresholds to trigger identification of an apparent delay for different portions of a particular commute.

If an apparent delay is identified, the operating server 104 may analyze specific characteristics of the identified delay at block 440. This may be done particularly so that the system may discriminate between actual commuting delays and attempts to cheat the commuting-rewards system. Possible cheating may be identified at block 442 by identifying travel patterns that suggest such behavior as driving unusually slowly when unnecessary according to known traffic patterns, taking unscheduled stops or route deviations, and the like. Identifying possible cheating at block 442 thus involves applying statistical comparisons to the commute. Such comparisons may include comparisons with data stored for prior commutes, by the user or by others, that occurred under similar traffic and weather conditions. They may also include comparisons with real-time data for commutes of other subscribers to the system whose commutes have portions in common with the route taken by the user. Specifically, apparent delay may be compared with a community of commuters traveling along the same route or route portion. The system can account for the before and after the block of time in which the anomaly occurred, with the gap being filled with average commuting measurements of others passing through that gap or by taking an average of the commuters traveling at any length of distance to fill the gap.

If potential cheating is recognized, corrective action may be taken at block 444. Such corrective action may include a wide range of different actions that are as simple as refusing to award reward points for the questionable commute to expulsion of the user from the program. Intermediate corrective actions may involve penalizing the user by debiting some of that user's previously accumulated reward points. In some embodiments, corrective action may be applied essentially automatically, relying on the accuracy of the statistical assessments, but in other embodiments corrective action may be preceded by an investigation. Such an investigation might seek to ascertain whether the anomalous behavior by the user, particularly in comparison to prior behavior by the user or to other similarly situated commuters, was caused legitimately, such as resulting from an automobile breakdown or the like.

If there is no identified cheating, the system may determine whether the delay qualifies as a super-outlier event at block 446, meaning that the statistical deviation from normal is severe. In one embodiment, for example, the statistical deviation may be at a level greater than three standard deviations away from normal. Such a statistical deviation may be evaluated, moreover, at a number of different levels. The deviation may be severe for the particular commute at issue or may be determined to be severe over a broader time period such as a week, a month, or a quarter. If a super-outlier event is identified, an immediate reward may be pushed to the mobile device at block 448. In embodiments where there are different service tiers, the specific nature of the reward may depend on the service tier of the user, but examples of potential immediate rewards include coupons for price reductions on meals at particular restaurants, coupons for gasoline purchases or oil changes, automatic enrollment in an automobile association, and the like.

Whether or not there is some apparent delay that is detectable by the system during the process of the commute itself, the commute time is recorded at block 450. This information is then available for updating the user statistics at block 452, better defining both the average and variation of commute time for that particular user. It is expected that the average time for a particular commute will exhibit changes over time. There may, for example, be seasonal variations as commuting times at certain times of the year when workers are more likely to be on vacation may be lower than at other times of the year. There may also be more systematic changes in commuting time as population patterns in cities change over time, as traffic patterns are affected by the opening or closing of roads, and the like.

At block 454, a determination is made whether the commuting time was abnormal so that the customer may be rewarded at block 456 with an augmentation in reward points if the commute was outside certain parameters that define a normal commute. The number of points awarded at block 456 may depend on the severity of the particular commute's deviation from normal, with more points be awarded for more severe deviations.

There are a variety of ways in which the normality of the commute may be defined for comparison at block 454. These may range from relatively simple definitions to considerably more complex definitions in different embodiments. An example of a simple definition is one that defines a commute as “normal” if the time it takes less than one standard deviation greater than the mean commute time. More complex determinations may take account of expected variations in commute time, of which the predictable seasonal variation mentioned above is just one example. Other examples include predictable variations depending on the day of the week, with certain days of the week systematically having lower or higher average commuting times than other days of the week. The occurrence of holidays may also be taken into account, with known holidays having predictable impacts on commuting time. Including these temporal parameters may determine, for example, whether a person who has a 20-minute commute on a Friday is entitled to a reward when the average commuting time for Fridays is 18 minutes, but the average commuting time over all days of the week is 26 minutes.

In a particular embodiment, the statistical methodology used to determine awards is intended to reflect the psychological ability of human beings to adapt to expectations. Specifically, each commuter is expected to develop a psychological adaptation to certain commuting patterns so that rewards are awarded when the frustration experienced by a commuter is determined to have crossed some threshold that is tied to that adaptation rather than determined on some absolute basis. To illustrate, consider commuters A and B. Commuter A travels from home to work on major highways in the very early morning when there is typically only light traffic. Commuter B travels from home to work on city roads at the peak morning travel time when those roads are congested, and where the traffic is very frequently affected by accidents. Even if commuters A and B both have an average commuting time of 45 minutes, a smaller incident that affects commuting time may cross commuter A's frustration threshold more easily than commuter B's because of their different adaptations. This may be accommodated in a simple fashion by the statistical measure used for variation in commute time. Even with the same mean commuting time, the more chaotic nature of commuter B's commute may be reflected with a higher standard deviation so that it requires a greater deviation in commuting time to trigger a reward at block 456.

FIG. 4C summarizes methods of redeeming awarded commuter reward points. At block 462, the user starts the application on the mobile device 140 so that the redemption function may be selected at block 464. The user may be presented with a number of redemption options, not only for the kind of reward to be used but also perhaps in the way it is to be used. The examples provided above for rewards pushed to the mobile device 140 in response to super-outlier events may also be used as rewards provided in exchange for accumulated reward points, but other rewards may also be made available, providing for discounts or free purchases of products or services at any number of participating merchants. Such rewards might be provided as coupons that can be transmitted directly to the mobile device, by conventional mail, or in any of a variety of other manners. Alternatively, the rewards might be provided at a physical merchant location by having the mobile device 140 interact with a merchant point-of-sale device to debit the accumulated reward points in exchange for sale of a product or service by the merchant. Similar immediate rewards may be obtained at virtual merchant locations when the user uses the mobile device 140 to access a merchant web page or otherwise links the commuter profile with a merchant through another mechanism for accessing the merchant web page.

Thus, when the user is presented with a variety of redemption options at block 466 and the user makes an appropriate selection at block 468, the reward points may be reduced in accordance with the selection at block 470 and a coupon or other mechanism for obtaining the actual reward generated and transmitted to the user at block 472.

There are a variety of supplementary functions that may be provided with the commuting application in different embodiments, just some of which are mentioned here explicitly. These include features intended to improve the commuting experience generally. For example, in some embodiments, a feature is provided by the application to have a notification sent automatically be the application by email, text message, or otherwise to a commuter's employer when the system detects that the commuter will arrive late. This feature may even use modeling based on known traffic patterns, weather, and the like to provide the employer automatically with an estimated time of arrival. This feature may be particularly useful for commuters who are constrained from using their mobile devices 140 during commutes because of the existence of local laws prohibiting mobile-device use while driving. It may also be used to inform friends or family of the delay by using a prepopulated list of individuals to be notified of commuting delays. In other embodiments, a speed-trap feature may integrate with systems that collect real-time information from other users of speed traps at certain locations so that alerts may be provided to the commuter. The system may also integrate with governmental programs that provide for the allocation of pretax income to commuting expenses. In some embodiments, employer accounts may be configured that allow employers to enroll their employees into the system and to load reward points to particular employees as a form of employment bonus. Still other supplementary functions that may be integrated with the system will be evident to those of skill in the art.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of rewarding a commuter, the method comprising:
determining a value of a characteristic of a commute by the commuter along a route from a first location to a second location;
comparing the value of the characteristic with a reference value for the characteristic for travel by the commuter along the route from the first location to the second location to determine that the determined value deviates from the reference value by more than a threshold amount; and
generating a reward to the commuter in response to determining that the determined value deviates from the reference value by more than the threshold amount.

2. The method recited in claim 1 wherein the value of the characteristic comprises a time for travel by the commuter along the route from the first location to the second location.

3. The method recited in claim 2 wherein the reference value of the characteristic comprises an average time for travel by the commuter along the route from the first location to the second location.

4. The method recited in claim 1 further comprising updating the value of the reference characteristic to account for the determined value of the characteristic.

5. The method recited in claim 1 wherein the threshold amount comprises a statistical measure of variation from the reference value for the characteristic for travel by the commuter along the route from the first location to the second location.

6. The method recited in claim 1 wherein the commute comprises a plurality of commutes along the route from the first location to the second location, the plurality of commutes having a further common quality.

7. The method recited in claim 1 wherein generating the reward to the commuter comprises augmenting a point record associated with the commuter and redeemable for goods and/or services.

8. The method recited in claim 1 wherein determining the value of the characteristic comprises monitoring a location of a mobile device associated with the commuter as the commuter travels along the route from the first location to the second location.

9. The method recited in claim 8 wherein determining the characteristic comprises predicting the value of the characteristic for an entirety of the commute from partial information of the commute collected while monitoring the location of the mobile device.

10. The method recited in claim 9 wherein generating the reward is performed before the commute by the commuter along the route from the first location to the second location is complete.

11. The method recited in claim 9 wherein predicting the value of the characteristic comprises accessing and applying external information collected from a source other than the mobile device.

12. A method of rewarding a commuter, the method comprising:
monitoring a location of a mobile device associated with the commuter as the commuter engages in a commute by traveling along a route from a first location to a second location;
determining a time for the commute;
comparing the time with an average time previously determined for a plurality of commutes by the commuter along the route from the first location to the second location;
determining that the time deviates from the average time by more than a statistical measure of variation from the average time; and
generating a reward to the commuter in response to determining that the determined time deviates from the average time by more than the statistical measure by augmenting a point record associated with the commuter and redeemable for goods and/or services.

13. A system for rewarding a commuter, the system comprising:
a processor;
a communications system in communication with the processor and with a network accessible by a mobile device associated with the commuter; and
a storage device in communication with the processor,
wherein the processor has:
instructions to monitor a location of the mobile device over the network through the communications system as the commuter engages in a commute by traveling along a route from a first location to a second location;
instructions to determine a value of a characteristic of the commute;
instructions to compare the value the characteristic with a reference value for the characteristic for travel by the commuter along the route from the first location to the second location, wherein the reference value is stored on the storage device;
instructions to determine that the determined value deviates from the reference value by more than at threshold amount, wherein the threshold value is stored on the storage device; and
instructions to generate a reward to the commuter in response to determining that the determined value deviates from the reference value by more than the threshold amount.

14. The system recited in claim 13 wherein the value of the characteristic comprises a time for travel by the commuter along the route from the first location to the second location.

15. The system recited in claim 14 wherein the reference value of the characteristic comprises an average time for travel by the commuter along the route from the location to the second location.

16. The system recited in claim 13 wherein the processor further has instructions to update a value of the reference characteristic on the storage device to account for the determined value of the characteristic.

17. The system recited in claim 13 wherein the threshold amount comprises a statistical measure of variation from the reference value for the characteristic for travel by the commuter along the route from the first location to the second location.

18. The system recited in claim 13 wherein:
the communications system is further in communication with a network that provides access to an external source of information; and
the instructions to determine the value of the characteristic of the commute comprise instructions to access and apply information collected from the external source of information.

19. The system recited in claim 13 wherein the instructions to generate the reward to the commuter comprise instructions to augment a point record associated with the commuter and redeemable for goods and/or services.

20. The system recited in claim 13 wherein the instructions to determine the characteristic comprise instructions to predict the value of the characteristic for an entirety of the commute from partial information of the commute collected while the location of the mobile device is monitored.
